(19) United States
(12) Patent Application Publication
(10) Pub. No.: US 2012/0054307 A1
(43) Pub. Date: Mar. 1, 2012

(54) DELIVERY SYSTEM, INFORMATION PROCESSING APPARATUS, INFORMATION PROCESSING PROGRAM, AND CONTENT ACQUIRING METHOD

(75) Inventor: Nobuyuki ASANO, Nagoya-shi (JP)

(73) Assignee: BROTHER KOGYO KABUSHIKI KAISHA, Nagoya-shi (JP)

(21) Appl. No.: 13/219,881

(22) Filed: Aug. 29, 2011

(30) Foreign Application Priority Data
Aug. 30, 2010 (JP) 2010-192758

(51) Int. Cl. G06F 15/16

(52) U.S. Cl. 709/217

(57) ABSTRACT

An information processing apparatus included in a delivery system in which a plurality of contents are stored in a plurality of node devices which are mutually communicate with each other through a network, includes: a first transmitting unit transmitting to, one of the node devices, a retrieval request indicative of a request for retrieving a location of a given content; a second transmitting unit transmitting an acquisition request indicative of a request for acquiring at least first data required for starting reproduction of the given content to a delivery device that saves the first data; a control unit configured controlling the first transmitting unit to transmit the retrieval request, and controlling the second transmitting unit to transmit the acquisition request; and an acquisition unit acquiring the given content in response to the retrieval request, and acquire the first data in response to the acquisition request.

### CROSS-REFERENCE TO RELATED APPLICATION

This application is based upon and claims the benefit of priority of Japanese Patent Application No. 2010-192758 filed on Aug. 30, 2010, the contents of which are incorporated herein by reference in its entirety.

### BACKGROUND

The present disclosure relates to a technical field of a delivery system of an overlay network having a plurality of node devices that can communicate with each other on a network.

In recent years, a peer to peer delivery system using the overlay network has been known. In the peer to peer delivery system, the overlay network is configured by a plurality of node devices. A plurality of content data is dispersedly saved in the plurality of node devices that enters into the overlay network. The locations of the content data dispersedly saved in the plurality of node devices on the overlay network can be efficiently retrieved with the use of a distributed hash table. In the following description, the content data is called “content”. In the above peer to peer delivery system, the concentration of loads on a delivery server as in a client-server delivery system can be reduced.

### SUMMARY

However, in the peer to peer delivery system, messages for retrieving the content dispersedly saved in the plurality of node devices on the overlay network buzz on the network. For that reason, in the peer-to-peer delivery system, it may take time to retrieve the location of the content, and there arises such a problem that the content cannot be acquired at a stable speed as compared with a case in which the content is acquired from the delivery server.

One aspect of the present disclosure has been made in view of the above circumstances, and therefore an object is to provide an information processing apparatus, an information processing program, a delivery system, and a content acquiring method, which can rapidly acquire a content at a stable speed.

An information processing apparatus included in a delivery system in which a plurality of contents are stored in a plurality of node devices which are mutually communicate with each other through a network, the information processing apparatus comprising:
a first transmitting unit configured to transmit to, one of the node devices, a retrieval request indicative of a request for retrieving a location of a given content;
a second transmitting unit configured to transmit an acquisition request indicative of a request for acquiring at least first data required for starting reproduction in the given content to a delivery device that saves the first data;
a control unit configured to control the first transmitting unit to transmit the retrieval request, and control the second transmitting unit to transmit the acquisition request; and
an acquisition unit configured to acquire the given content in response to the retrieval request transmitted by the first transmitting unit, and acquire the first data in response to the acquisition request transmitted by the second transmitting unit.

A non-transitory computer readable storage medium storing an information processing program executable by the computer included in a delivery system in which a plurality of contents are stored in a plurality of node devices which are mutually communicate with each other through a network, the information processing program comprising instruction of:
transmitting to, one of the node devices, a retrieval request indicative of a request for retrieving a location of a given content;
transmitting an acquisition request indicative of a request for acquiring at least first data required for starting reproduction in the given content to a delivery device that saves the first data; and
acquiring the given content in response to the transmitted retrieval request; and
acquiring the first data in response to the transmitted acquisition request.

A delivery system in which a plurality of contents are stored in a plurality of node devices which are mutually communicate with each other through a network, the delivery system comprising:

a first transmitting unit configured to transmit to, one of the node devices, a retrieval request indicative of a request for retrieving a location of a given content;

a second transmitting unit configured to transmit an acquisition request indicative of a request for acquiring at least first data required for starting reproduction in the given content to a delivery device that saves the first data;

a control unit configured to control the first transmitting unit to transmit the retrieval request, and control the second transmitting unit to transmit the acquisition request; and

an acquisition unit configured to acquire the given content in response to the retrieval request transmitted by the first transmitting unit, and acquire the first data in response to the acquisition request transmitted by the second transmitting unit.

A method of acquiring a content in a delivery system in which a plurality of contents are stored in a plurality of node devices which are mutually communicate with each other through a network, the method comprising:

transmitting to, one of the node devices, a retrieval request indicative of a request for retrieving a location of a given content;

transmitting an acquisition request indicative of a request for acquiring at least first data required for starting reproduction in the given content to a delivery device that saves the first data; and

acquiring the given content in response to the transmitted retrieval request; and

acquiring the first data in response to the transmitted acquisition request.

### BRIEF DESCRIPTION OF THE DRAWINGS

FIG. 1 is a diagram illustrating an outline configuration example of a content delivery system according to this embodiment.

FIG. 2A is a block diagram illustrating an outline configuration example of a web server.

FIG. 2B is a block diagram illustrating an outline configuration example of a node.

FIG. 2C is a block diagram illustrating an outline configuration example of a viewing terminal.

FIGS. 3A and 3B are flowcharts illustrating content acquisition processing in a control unit of the node.

FIG. 3C is a diagram illustrating an example in which a content is developed on a reproduction time axis.

### DESCRIPTION OF EXEMPLARY EMBODIMENTS

Hereinafter, an exemplary embodiment will be described with reference to the accompanying drawings. In the description below, a content delivery system according to the exemplary embodiment is.

### 1. Outline of the Configuration and Operation of Content Delivery System

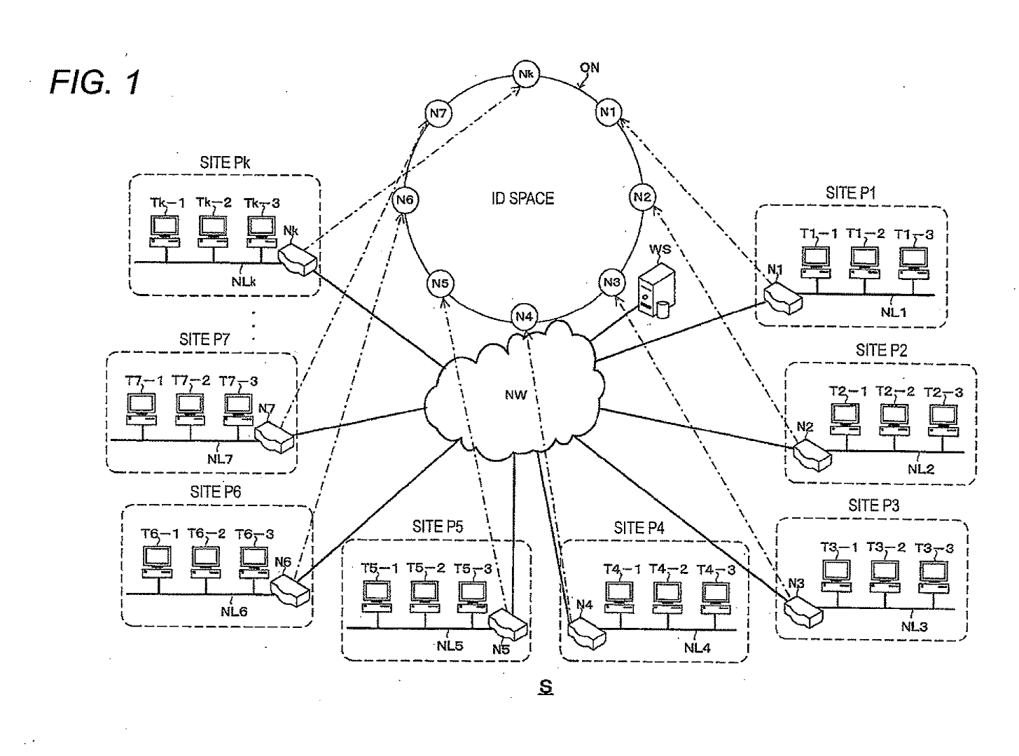

First, the outline of the configuration and operation of the content delivery system according to this embodiment will be described with reference FIG. 1. As illustrated in FIG. 1, a content delivery system S according to this embodiment includes a web server WS, and node devices Nn (n=1, 2, 3, . . . j). The web server WS and the node devices Nn are connected to a network NW. The network NW includes an internet. The web server WS configures a delivery site that puts a content such as a moving image on the network NW. The web server WS exemplifies an information processing apparatus and a stationary device according to the present invention. In the following description, the node device is called “node”.

As illustrated in FIG. 1, the content delivery system S includes a local area network NLn in each of a plurality of sites Pn. The sites are, for example, karaoke bars, schools, companies, housings, and other facilities. Each site network NLn is a private network such as a local area network (LAN). Each site network NLn is connected with a node Nn and a plurality of viewing terminals Tn-1 (l=1, 2, 3). The node Nn at each site Pn functions as an edge server that provides a content to the viewing terminals Tn-1 connected to the same site network NLn. The viewing terminal Tn-1 is an example of the terminal device according to the present invention. The viewing terminals Tn-1 at each site Pn do not always communicate with only the node Nn connected to the same site network NLn. For example, the viewing terminal T1-1 at the site P1 can communicate with both the node N1 connected to the same site network NL1, and a node N2 at another site P2 or the web server WS. As illustrated in FIG. 1, in the content delivery system S, an overlay network ON is configured by entries of the plurality of nodes Nn (n=1, 2, 3, . . . k) that can communicate with each other through the network NW. The overlay network ON is a logical network configuring a virtual link. The overlay network ON is realized by a specific algorithm, for example, an algorithm using a distributed hash table. The distributed hash table is hereinafter called “DHT”). The entry of the node to the overlay network ON means that one node Nn operates so as to transmit or receive various messages with respect to another node Nn through the overlay network ON on the basis of a routing table using the DHT. The routing table using the DHT has been known by JP-A-2006-197400 which is incorporated by reference herein, and therefore its detail description will be omitted.

In this embodiment, the respective nodes Nn steadily enter into the overlay network ON. In the present specification, “steadily enter” means, for example, that the nodes Nn enter into the overlay network ON without withdrawing therefrom except that the node Nn fails or is maintained. In this embodiment, the nodes Nn that steadily enter into the overlay network ON are, for example, routers. In this case, a program for causing each of the routers to execute control processing as the node Nn is installed in the router. The program for causing a device always connected to the network to execute the control processing as the node Nn may be installed in each home except for the respective sites. A node ID is allocated to each node Nn that enters into the overlay network ON. The node ID is unique identification information for identifying the node Nn from the nodes Nn that enter into the overlay network ON. Various contents different in content may be dispersedly saved in the plurality of nodes Nn that enter into the overlay network ON. The content may be, for example, karaoke data used in karaoke bars. The karaoke data is hereinafter called “karaoke content”. In this case, the overlay network ON is configured such that one node Nn acquires the karaoke content from another node Nn.

A content ID is allocated to each content saved in each node Nn on the overlay network ON. A content ID is unique identification information for identifying the content from the contents saved in the nodes Nn on the overlay network ON. The node ID and the content ID are generated by, for example, a common hash function on the overlay network ON.

Incidentally, the node Nn that saves the content therein is hereinafter called “content holding node”. Information indicative of the location of the content is stored in the node Nn that manages the location of the content as index information. The node Nn that manages the location of the content is hereinafter called “root node”. The index information includes a set of the node information on the content holding node that saves the content therein and the content ID of the content. The node information includes, for example, an IP address of the content holding node, a port No., and the node ID. The root node is determined, for example, as the node Nn to which the node ID closest to the content ID is allocated. The node ID closest to the content ID is, for example, the node ID in which the most higher-order digits of the ID match each other.

Further, each node Nn that enters into the overlay network ON has a function of a hypertext transfer protocol (HTTP) proxy. For that reason, the node Nn receives an HTTP request transmitted from the viewing terminal Tn-1. The HTTP request is an example of the acquisition request indicative of a request for acquiring a given content. If the node Nn is a general HTTP proxy, the node Nn conducts retrieval processing for retrieving the location of a given content requested by the HTTP request from the overlay network ON without transferring the HTTP request transmitted from the viewing terminal Tn-1 to the web server WS as it is. The node Nn that conducts the retrieval processing is hereinafter called “user node”. In the retrieval processing, the user node transmits a retrieval request indicative of a request for retrieving the location of the requested content to a given node Nn on the overlay network ON. More specifically, the user node first generates a content location inquiry message including the retrieval request. The content location inquiry message is used to inquire of the root node about the location of the content corresponding to the retrieval request. The content location inquiry message includes an IP address and port No. of the user node that transmits the inquiry message, and the content ID of the content corresponding to the retrieval request therein. The content ID is generated, for example, on the basis of a URL of the content included in the HTTP request. The user node transmits the content location inquiry message to a given node Nn on the overlay network ON on the basis of the routing table with the use of the DHT. The content location inquiry message thus transmitted is transmitted to the root node of the content corresponding to the retrieval request by DHT routing. The DHT routing has been known by, for example, No. 2008/144636 A1, which is incorporated herein by reference, and therefore its detailed description will be omitted. The root node that has received the content location inquiry message acquires the index information corresponding to the content ID included in the content location inquiry message. The root node returns the acquired index information to the user node. The index information thus returned includes the IP address of at least one content holding node that saves the content corresponding to the retrieval request therein. The user node thus acquires the index information from the root node as a result of the retrieval request. The user node accesses to the content holding node on the basis of the IP address of the content holding node included in the acquired index information. The user node acquires the content corresponding to the retrieval request from the content holding node. The content thus acquired is transferred to the viewing terminal Tn-1 that has transmitted the HTTP request.

Incidentally, when the content is acquired from the content holding node, there is a need to retrieve the location of the content through the above-mentioned retrieval processing. In this case, because the contents dispersedly saved in the plurality of nodes Nn are retrieved on the overlay network ON, the messages may buzz on the network NW. For that reason, in this case, as compared with a case in which the content is acquired from the web server WS, the acquisition of the content may be delayed. Under the circumstances, in this embodiment, the user node transmits the retrieval request of the content requested by the HTTP request as described above, and also transmits the acquisition request indicative of the request for acquiring at least partial data required for starting reproduction in the content to the web server WS as with the general HTTP proxy server. In this embodiment, the web server WS does not belong to the overlay network ON. However, the web server WS may belong to the overlay network ON. The term “belong” means that the web server WS enters into the overlay network ON. In this example, the acquisition request indicative of the request for acquiring the partial data is included in, for example, the HTTP request, and transmitted to the web server WS. The partial data is hereinafter called “partial data”. As a result, the user node can acquire at least the partial data required for starting the reproduction, corresponding to the acquisition request, from the web server WS through the client-server system until the content is acquired from the content holding node. At least the partial data required for starting the reproduction, which has been acquired by the user node, is transferred to the viewing terminal Tn-1 that has transmitted the HTTP request. As a result, the viewing terminal Tn-1 can rapidly start the reproduction of the content with the use of the partial data required for starting the reproduction without waiting for the content acquired through the overlay network ON.

### 2. Configuration and Function of the Web Server Ws

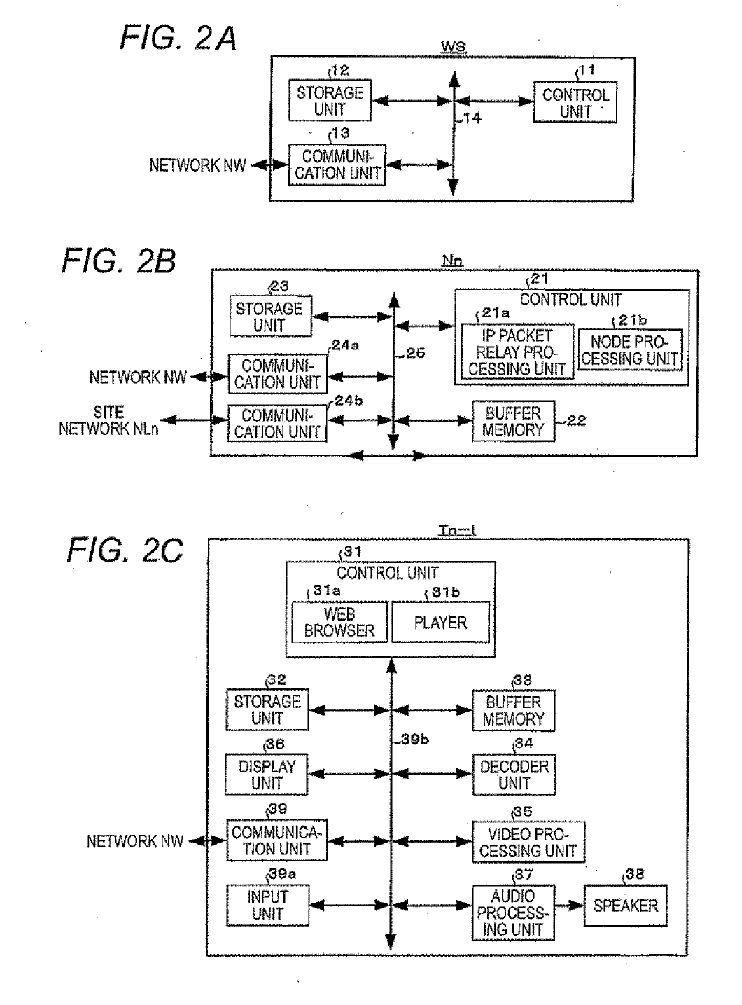

Subsequently, a description will be given of the configuration and function of the web server WS with reference to FIG. 2A. As illustrated in FIG. 2A, the web server WS includes a control unit 11, a storage unit 12, and a communication unit 13. The control unit 11, the storage unit 12, and the communication unit 13 are connected to each other through a bus 14. The web server WS may be configured by a plurality of servers such as an application server and a database server.

The storage unit 12 is configured by, for example, a hard disk drive. An operating system and a server program are stored in the storage unit 12. The content registered in a distribution site is stored in a content saving region provided in the storage unit 12 in a given file format. This content is configured by a resource file to be reproduced. In this example, the resource file includes, for example, a moving image file, an image file, an audio file, or a text file. The moving image file is exemplified by a wmv file, an asf file, a flv file, or a 3gp file. The image file is exemplified by a bmp file, a jpeg file, or a gif file. The audio file is exemplified by an mp3 file. The text file is exemplified by an XML file.

The content may include a resource file and a control file necessary for reproducing the resource file. The control file is exemplified by an swf file. In the swf file, a script for controlling the output of the resource such as the moving image is described in a language called “action script”. In this example, the output control includes, for example, the control of an output timing of the resource such as the moving image stored in the resource file. In other words, the output timing is a time that has been elapsed since the resource such as each moving image starts to be reproduced. The output control may include a display control for displaying an image or a text on a given display. The display control includes the control of the display position of, for example, the image or the text.

The content may include a plurality of resource files and a control file necessary for reproducing the respective resource files. In this case, in the control file, for example, the order of reproducing the respective resource files is specified.

Web pages that can be provided to the viewing terminal Tn-1 are stored in the storage unit 12. Each web page includes a structured document file described by a hypertext markup language (HTML) or an extensible markup language (XML). An identifier of a player which is software for reproducing the content is described in the web page. Further, location information indicative of the location of the content that can be provided to the viewing terminal Tn-1 is described in the web page. The location information is exemplified by the uniform resource locator (URL) of the content. The URL is an example of the URI. The URI includes the URL for identifying the location of the resource and an URN for identifying the name of the resource. A file path and a file name of the file configuring the content are included in the URL. The URL of a metafile of the content is described in the web page. The metafile of the content is a text file for a web browser to access to the content from the web page. For that reason, the URL of the content is described in the metafile of the content. The metafile is exemplified by the wvx file or the asx file. With the use of this metafile, the web browser can start the player indicated on the web page, and reproduce the streaming of the content. One content may include a plurality of files. In this case, the URI of each file configuring the content is described in the metafile of the content.

The communication unit 13 controls a communication with the viewing terminal Tn-1 or the node Nn through the network NW.

The control unit 11 includes a CPU having a computation function, and a RAM for operation, and a ROM. In the control unit 11, the CPU reads and executes a program stored in the storage unit 12 to conduct the processing as the web server WS.

### 3. Configuration and Function of the Node Nn

Subsequently, a description will be given of the configuration and function of the node Nn with reference to FIG. 2B. As illustrated in FIG. 2B, the node Nn includes a control unit 21, a buffer memory 22, a storage unit 23, a communication unit 24a, and a communication unit 24b. The control unit 21, the buffer memory 22, the storage unit 23, the communication unit 24a, and the communication unit 24b are connected to each other through a bus 25. In this embodiment, it is assumed that the node Nn is a relay device that relays an internet protocol (IP) packet between the network NW and the site network NLn. The relay device is configured by, for example, a router or an L3 switching hub.

The buffer memory 22 temporarily stores the content received through the communication unit 24a therein.

The storage unit 23 is configured by, for example, a hard disk drive. In the storage unit 23 are stored an operating system, an IP packet relay processing program, and a node processing program. The node processing program may be, for example, downloaded from a given server connected to the network NW. The node processing program may be, for example, recorded in a recording medium, and read through a drive of the recording medium.

A routing table employing the DHT used in the overlay network ON is stored in the storage unit 23. The content is stored in a content saving region provided in the storage unit 23. The content is identical with the content stored in the storage unit 12 of the web server WS. The content may include a plurality of files. In this case, for example, each file is dispersedly saved in the plurality of nodes Nn that enters into the overlay network ON as one content. For that reason, one of the plural files configuring the content may be stored in the storage unit 23 of one node Nn. For example, it is assumed that the content includes a first moving image file, a second moving image file, and a control file. In this case, the first moving image file is saved in the storage unit 23 of, for example, the node N1. The second moving image file is saved in the storage unit 23 of, for example, the node N2. Further, the control file is saved in the storage unit 23 of, for example, the node N3. The respective unique contents IDs are allocated to the respective files thus dispersedly saved as the content.

The communication unit 24a controls communication with another node Nn or the web server WS through the network NW. The communication unit 24b controls communication with the viewing terminal Tn-1 through the site network NLn.

The control unit 21 includes a CPU having a computation function, an operation RAM, and a ROM. The control unit 21 is an example of a receiving unit, a first transmitting unit, a second transmitting unit, a determining unit, a control unit, and an acquiring unit. The control unit 21 operates as an IP packet relay processing unit 21a by execution of the IP packet relay processing program. The IP packet relay processing unit 21a relays the IP packet from another router or a host in a network layer that is a third layer of an open systems interconnection (OSI) reference model. The function of the IP packet relay processing unit 21a is identical with that of a known router or an L3 switching hub, and therefore its detailed description will be omitted. The control unit 21 operates as a node processing unit 21b by execution of the node processing program stored in the storage unit 23 through a CPU. The processing of the IP packet relay processing unit 21a and the node processing unit 21b is executed by a multitask or a multicore of one CPU. Alternatively, the processing of the IP packet relay processing unit 21a and the node processing unit 21b may be executed by the respective two CPUs.

### 4. Configuration and Function of the Viewing Terminal Tn-1

Subsequently, a description will be given of the configuration and function of the viewing terminal Tn-1 with reference to FIG. 2C. As illustrated in FIG. 2C, the viewing terminal Tn-1 includes a control unit 31, a storage unit 32, a buffer memory 33, a decoder unit 34, a video processing unit 35, a display unit 36, an audio processing unit 37, a speaker 38, a communication unit 39, and an input unit 39a. The control unit 31, the storage unit 32, the buffer memory 33, the decoder unit 34, the video processing unit 35, the display unit 36, the audio processing unit 37, the communication unit 39, and the input unit 39a are connected to each other through a bus 39b. A personal computer or a karaoke equipment can be applied to the viewing terminal Tn-1. The karaoke equipment is a device for reproducing a karaoke content.

The storage unit 32 is configured by, for example, a hard disk drive. An operating system, a program of a web browser, and a program of a player are stored in the storage unit 32. An IP address and a port No. of the web server WS are stored in the storage unit 32.

The buffer memory 33 buffers the received content. The decoder unit 34 conducts decoding such as data expansion or decoding of video data or audio data included in the content. The video processing unit 35 conducts given drawing processing on the video data decoded by the decoder unit 34 to reproduce and output the video data as a video signal. The display unit 36 displays a video picture on a display on the basis of the video signal reproduced and output from the video processing unit 35. The display unit 36 displays the image decoded by the decoder unit 34. The audio processing unit 37 subjects the audio signal decoded by the decoder unit 34 to digital (D)/analog (A) conversion into an analog audio signal, and thereafter amplifies the audio signal, and reproduces and outputs the amplified signal. The speaker 38 outputs the audio signal reproduced and output from the audio processing unit 37 as an acoustic wave.

The communication unit 39 controls communication with the web server WS or the node Nn through the network NW.

The control unit 31 includes a CPU having a computation function, an operation RAM, and a ROM. The control unit 31 operates as a web browser 31a by execution of a program of the web browser stored in the storage unit 32 through a CPU. A web page acquired from the web server WS by the web browser 31a is displayed on the display. The control unit 31 operates as a player 31b by execution of a program of the player stored in the storage unit 32 through the CPU. The decoder unit 34 is controlled by the player 31b to reproduce the content.

Like the control unit 21 of the node Nn, the control unit 31 may function as the node processing unit by execution of the node processing program. In this case, the viewing terminal Tn-1 can enter into the overlay network ON, and operate as the node Nn.

### 5. Operation of the Content Delivery System S

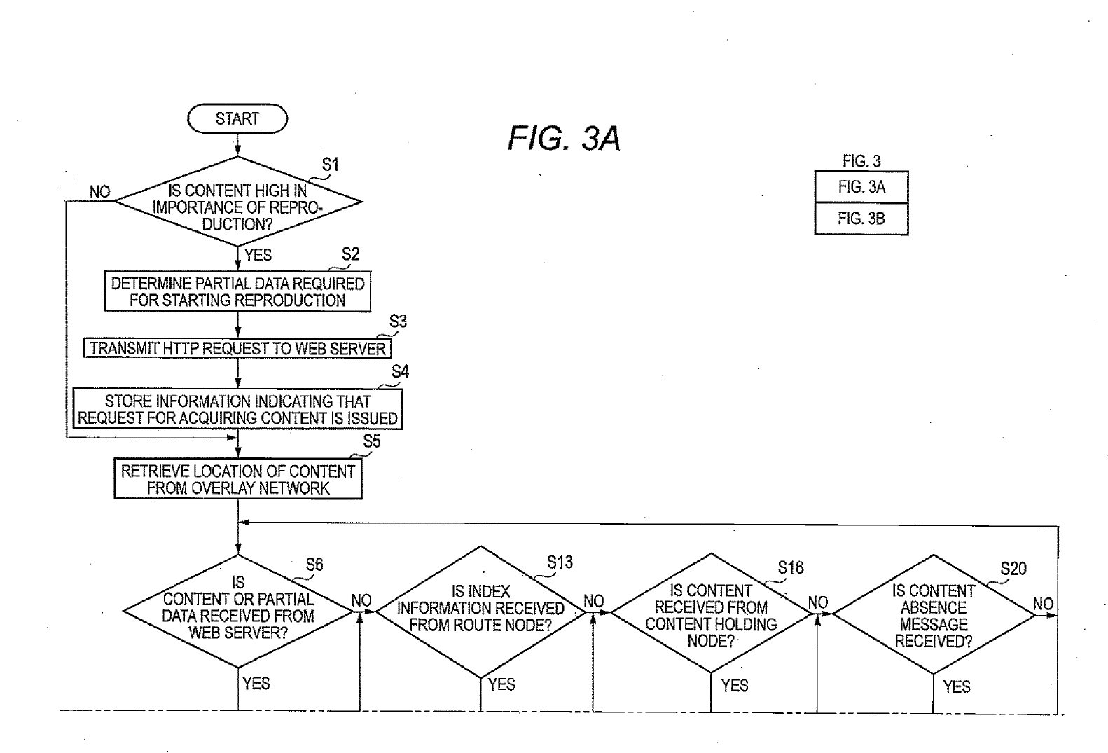

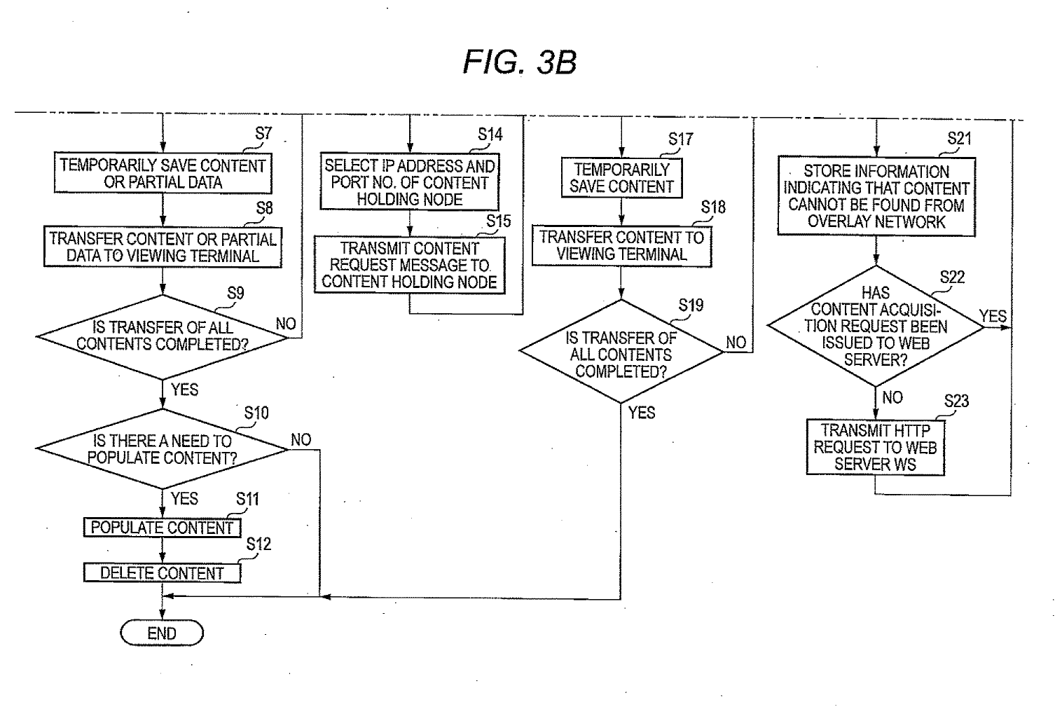

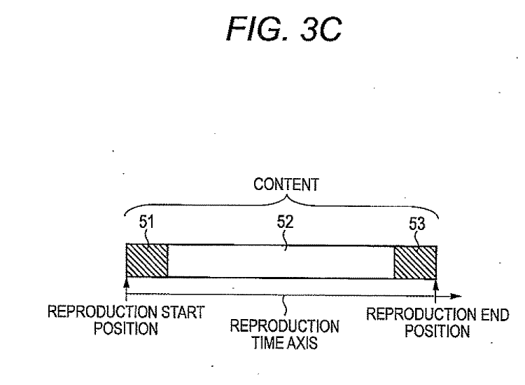

Subsequently, a description will be given of the operation of the content delivery system S according to this embodiment with reference to FIGS. 3A to 3C. In the following description, the node N1 and the viewing terminal T1-1 are exemplified. It is assumed that the web page received from the web server WS by the web browser 31a is displayed on the display unit 36 of the viewing terminal Tn-1. The web page is a page for viewing the content put on the distribution site. The web page includes the URL of the content or the URL of the metafile of the content. In a state where the web page is thus displayed, for example, it is assumed that the reproduction of the content is instructed by a user of the viewing terminal Tn-1 through the input unit 39a. In this case, the web browser 31a of the viewing terminal T1-1 transmits an HTTP request indicative of a request for acquiring the content the reproduction of which is required to the node N1 through the site network NL1. Alternatively, the HTTP request may be transmitted to the node N1 on condition that the web browser 31a receives the web page. The HTTP request includes the URL of the content extracted from the web page. The web page may include the URL of the metafile of the content. In this case, the web browser 31a first acquires the metafile of the content to extract the URL of the content from the metafile. The web browser 31a transmits the HTTP request including the URL of the extracted content to the node N1. One content may include a plurality of files. In this case, the URL of each file is included in the HTTP request.

The processing illustrated in FIGS. 3A and 3B starts when the node N1 receives the HTTP request from the viewing terminal T1-1. When the processing illustrated in FIGS. 3A and 3B starts, the node processing unit 21b of the node N1 determines whether the content requested from the viewing terminal T1-1 is high in the importance of reproduction, or not (Step S1). This determination is conducted for determining whether partial data required for starting the reproduction in the content is acquired from the web server WS, or not. In this example, the content high in the importance of reproduction means, for example, a content to be started to be rapidly reproduced since the viewing terminal T1-1 receives the content. In other words, the content high in the importance of reproduction is a reproduction-oriented content.

A method of determining whether the content is higher in the importance of reproduction, or not, is exemplified by the following determination methods (a) to (d).

(a) Determination Based on Whether Streaming Reproduction is Conducted, or not

There is a case in which the streaming reproduction of the content is required according to the HTTP request from the viewing terminal T1-1. The content to be subjected to the streaming reproduction is a content to be started to be rapidly reproduced since the viewing terminal T1-1 receives the content. For that reason, the node processing unit 21b determines that the content requested from the viewing terminal T1-1 is high in the importance of reproduction if the content is to be subjected to the streaming reproduction. In this embodiment, the content to be subjected to the streaming reproduction means a content to be started to be reproduced when a given amount of data is buffered in the buffer memory 33. The information indicating that the content is to be subjected to the streaming reproduction is described in the web page. For that reason, in this case, a header of the HTTP request transmitted from the viewing terminal T1-1 includes information indicating that the content is to be subjected to the trimming reproduction. According to the determination method of (a), the viewing terminal T1-1 can rapidly start the streaming reproduction of the content. On the other hand, if the content requested from the viewing terminal T1-1 is not to be subjected to the streaming reproduction, a processing load of the web server WS can be reduced.

(b) Determination Based on the Reproduction Order of Plural Contents

There is a case in which a plurality of contents to be reproduced in turn is requested according to the HTTP request from the viewing terminal T1-1. A content to be first reproduced among the plurality of contents is to be started to be rapidly reproduced since the viewing terminal T1-1 receives the content. For that reason, the node processing unit 21b determines that the content to be first reproduced in the plurality of requested contents is high in the importance of reproduction. For example, there is a case in which the viewing terminal T1-1 is a karaoke equipment, and a karaoke content is requested. In this case, the node processing unit 21b determines that a first content reserved in the karaoke equipment is high in the importance of reproduction. On the other hand, contents secondly or subsequently reproduced among the plurality of contents may be reproduced after the first content has been reproduced. For that reason, the node processing unit 21b determines that such contents are not high in the importance of reproduction. The header of the HTTP request transmitted from the viewing terminal T1-1 includes information indicative of the reproduction order or the reservation order of tracks corresponding to the respective contents. For example, there is a case in which the reservation of the second or subsequent contents is instructed from the user through the communication unit 39. In this case, the node processing unit 21b determines that the requested second or subsequent contents are not high in the importance of reproduction. In this case, the header of the HTTP request includes information indicating that the content is the reserved second or subsequent content. According to the determination method of (b), the viewing terminal T1-1 can rapidly start the reproduction of the first content among the plurality of contents. On the other hand, when the content requested from the viewing terminal T1-1 is the second or subsequent content, the processing load of the web server WS can be reduced.

(c) Determination Based on the Kind of Content

The kinds of contents are, for example, a moving image, a still image, sound, and a text. The moving image is also called “video picture”. Among those kinds, the content of the moving image is to be started to be rapidly reproduced since the viewing terminal T1-1 receives the content. For that reason, if the content requested from the viewing terminal T1-1 is the content of the moving image, the node processing unit 21b determines that the content is high in the importance of reproduction. On the other hand, the content of the still image cannot be viewed without providing all of the image files, and therefore it is conceivable that there is no advantage in partially rapidly acquiring the image files. For that reason, the node processing unit 21b determines that such content is not high in the importance of reproduction. The kind of content can be discriminated according to the URL of the content included in the HTTP request transmitted from the viewing terminal T1-1. For example, the URL of the content includes each file name of the files configuring the content. The kind of content can be discriminated according to an extension included in the file name. If the extension is, for example, “wmv”, “flv”, or “3gp”, the node processing unit 21b can determine that the content is the moving image. The extension included in the file name is an example of the information indicative of the kind of moving image. According to the determination method of (c), the viewing terminal T1-1 can rapidly start the reproduction of the content of the moving image.

(d) Determination Based on Emphasized Stream

In a case where the content includes both data of an audio stream and a video stream, any stream may be more emphasized. In this example, the stream means a continuous flow. For example, in the case of the karaoke content, the disconnection of the audio stream is problematic even if the disconnection is instantaneous. However, the instantaneous stop of the moving image stream is not largely problematic in the intended purpose of the karaoke. Data of the audio stream is stored in the audio file. On the other hand, the data of the video stream is stored in the moving image file. In this case, the node processing unit 21b determines that the audio file of the audio file and the moving image file which configure the content requested from the viewing terminal T1-1 is the content high in the importance of reproduction. On the other hand, the node processing unit 21b determines that the moving image file of the audio file and the moving image file which configure the requested content is the content high in the importance of reproduction. The distinction between the audio file and the moving image file can be conducted by, for example, the extension included in the file name. According to the determination method of (d), the viewing terminal T1-1 can rapidly start the emphasized stream reproduction.

Other determination methods different from the above methods (a) to (d) may be applied. For example, it is conceivable that the content to be rapidly acquired by the user of the viewing terminal T1-1 is designated as a content high in the importance of reproduction. In this case, the header of the HTTP request transmitted from the viewing terminal T1-1 includes information indicating that the content is high in the importance of reproduction.

When the node processing unit 21b of the node N1 determines that the content requested from the viewing terminal T1-1 is not high in the importance of reproduction (no in Step S1), the processing is advanced to Step S5. That is, at this time, the node processing unit 21b prohibits the HTTP request indicative of a request for acquiring the content from being transmitted to the web server WS. In this case, if the content can be found from the overlay network ON, since the content is not requested from the node processing unit 21b to the web server WS, the processing load of the web server WS can be reduced.

On the other hand, when the node processing unit 21b determines that the content requested from the viewing terminal T1-1 is high in the importance of reproduction (yes in Step S1), the processing is advanced to Step S2.

In Step S2, the node processing unit 21b of the node N1 determines the partial data required for starting the reproduction in the content requested from the viewing terminal T1-1. The partial data required for starting the reproduction is exemplified by data for controlling the output control of the moving image. Data for conducting the output control of the moving image is included in data 51 of a given size extending from a reproduction start position to a given byte on a reproduction time axis of the content, for example, as illustrated in FIG. 3C. For that reason, the node processing unit 21b determines the data 51 of the given size as the partial data required for starting the reproduction. FIG. 3C illustrates an example in which the content is developed on the reproduction time axis. The reproduction start position on the reproduction time axis is a O-byte position of the content.

Depending on the format of the content, data for conducting the output control of the moving image may be included in data 53 of a given size extending from a given byte to a reproduction end position on the reproduction time axis of the content, as illustrated in FIG. 3C. In this case, the node processing unit 21b determines the data 53 of the given size as the partial data required for starting the reproduction. Alternatively, data for conducting the output control of the moving image is separately included in the data 51 of the given size extending from the reproduction start position to a first byte on the reproduction time axis of the content, and the data 53 of the given size extending from a second byte larger than the first byte to the reproduction end position. In this case, the node processing unit 21b determines the data 51 of the given size and the data 53 of the given size as the partial data required for starting the reproduction.

There is a case in which the content requested from the viewing terminal T1-1 is configured by a plurality of resource file. A reproduction order is set in each of the resource, files. In this case, the node processing unit 21b may determine a resource file that is first in the reproduction order, or resource files that are first to a given order in the reproduction order as the partial data required for starting the reproduction.

The content requested from the viewing terminal T1-1 is configured by the resource file and the control file required for reproducing the resource file. In this case, the node processing unit 21b may determine the control file as the partial data required for starting the reproduction.

In the above-mentioned determination method of (d), it may be determined that the audio file is the content high in the importance of reproduction whereas it may be determined that the moving image file is the content low in the importance of reproduction. In this case, the node processing unit 21b may determine the audio file as the partial data required for starting the reproduction.

The node processing unit 21b transmits the HTTP request indicative of a request for acquiring the partial data required for starting the reproduction determined in the above Step S2 through the client-server system, to the web server WS through the network NW (Step S3). In this example, the HTTP request includes the URL of the content requested from the viewing terminal T1-1, and information indicative of a range of the partial data required for starting the reproduction in the content therein. The range of the partial data is represented by X byte to Y byte. It may be determined that the partial file in the plurality of files configuring one content is the partial data required for starting the reproduction. In this case, the HTTP request includes the URL of the file determined as the partial data required for starting the reproduction. In this way, when the data required of the web server WS is only the partial data required for starting the reproduction, the processing load of the web server WS can be suppressed to a given amount or lower.

The node processing unit 21b of the node N1 may transmit, to the web server WS, the HTTP request indicative of a request for acquiring all of data in the content requested from the viewing terminal T1-1. According to this configuration, the content requested from the viewing terminal T1-1 can be acquired from the web server WS in a complete form. For that reason, when the node processing unit 21b cannot find the content from the overlay network ON, the node processing unit 21b can populate the content acquired from the web server WS into the overlay network ON. In this case, the node processing unit 21b may transfer the HTTP request including the URL of the content requested from the viewing terminal T1-1 to the web server WS, and therefore the efficiency is high. In this example, “populate the content” means that a new content is saved in any node Nn as a content that can be acquired on the overlay network ON.

When the web server WS receives the HTTP request transmitted from the node N1, the web server WS acquires the content indicated by the URL included in the HTTP request, and transmits the acquired content to the node N1. When the information indicative of the range of the partial data is included in the HTTP request, the partial data in this range is acquired, and transmitted to the node N1.

Then, the node processing unit 21b of the node N1 stores information indicating that a request for acquiring the content is issued to the web server WS (Step S4), and the processing is advanced to Step S5.

In Step S5, the node processing unit 21b of the node N1 conducts retrieval processing for retrieving the location of the content requested from the viewing terminal T1-1, from the overlay network ON. More specifically, the node processing unit 21b of the node N1 generates a content location inquiry message including the content ID of the content required from the viewing terminal T1-1. The node processing unit 21b transmits the generated content location inquiry message to a root node of the content through the DHT routing. In this example, the content ID is generated by, for example, hashing the URL of the content by the aid of the same hash function as the hash function for generating the node ID. In this case, the hash value of the URL of the content is the content ID. Since the content ID is thus generated on the basis of the URL of the content, the description of the web page may not be changed for the purpose of describing the content ID of the content populated into the overlay network ON.

Incidentally, there is a case in which the URLs of the respective files configuring the content requested from the viewing terminal T1-1 are included in the HTTP request. In this case, the content ID of the respective files is generated on the basis of the URLs of the respective files. The content location inquiry message including the content ID thus generated is generated in each file. The respective generated content location inquiry messages are transmitted to the root nodes of the respective files.

There is a case in which partial files among the plurality of files configuring one content are required of the web server WS as the partial data required for starting the reproduction. In this case, the content ID of the file is generated on the basis of the URL of the file other than the partial files. Then, the content location inquiry message including the content ID thus generated is transmitted to the root node of the file. That is, a retrieval request indicative of a request for retrieving the content including data except data required for starting the reproduction is transmitted to the root node. The number of content location inquiry messages transmitted from the node N1 can be suppressed.

Upon receiving the content location inquiry message transmitted from the node N1, the root node acquires index information corresponding to the content ID included in the content location inquiry message, and transmits the acquired index information to the node N1. On the other hand, there is a case in which index information corresponding to the content ID included in the content location inquiry message is not stored. In this case, the root node transmits a content absence message to the node N1. The content absence message indicates that there is no content holding node that saves the content corresponding to the content ID included in the content location inquiry message.

In the above example, the control unit 31 allows the node processing unit 21b to transmit the content location inquiry message to a given node Nn, and to transmit the HTTP request to the web server WS within a given time before transmission of the content location inquiry message. Alternatively, the transmission of the content location inquiry message may be conducted before the HTTP request is transmitted to the web server WS in the above Step S3. That is, the control unit 31 allows the node processing unit 21b to transmit the content location inquiry message to the given node Nn, and to transmit the HTTP request to the web server WS within a given time after transmission of the content location inquiry message. Alternatively, the content location inquiry message and the HTTP request in the above Step S3 may be transmitted at the same time.

In Step S6, the node processing unit 21b of the node N1 determines whether the content or the partial data required for starting the reproduction has been received from the web server WS, or not. If the content or the partial data required for starting the reproduction has been received from the web server WS (yes in Step S6), the processing is advanced to Step S7. On the other hand, if the content or the partial data required for starting the reproduction has not been received from the web server WS (no in Step S6), the processing is advanced to Step S13.

In Step S7, the node processing unit 21b of the node N1 temporarily saves the content or the partial data required for starting the reproduction, which has been received from the web server WS, in the buffer memory 22.

Then, the node processing unit 21b of the node N1 transfers the content or the partial data required for starting the reproduction, which has been received from the web server WS, to the viewing terminal T1-1 through the site network NL1 (Step S8). Upon receiving the content or the partial data required for starting the reproduction, the web browser 31a of the viewing terminal T1-1 starts the player 31b corresponding to an identifier of a player described in the web page. Then, the player 31b allows the reproduction of the content to start.

Then, the node processing unit 21b of the node N1 determines whether all of the contents requested from the viewing terminal T1-1 have been transferred, or not (Step S9). Then, if the node processing unit 21b of the node N1 determines that all of the contents have been transferred to the viewing terminal T1-1 (yes in Step 9), the processing is advanced to Step S10. On the other hand, if the node processing unit 21b of the node N1 determines that all of the contents have not yet been transferred to the viewing terminal T1-1 (no in Step 9), the processing is advanced to Step S13.

In Step S10, the node processing unit 21b of the node N1 determines whether there is a need to populate the content acquired from the web server WS through the client-server system into the overlay network ON, or not. For example, if information indicating that the content cannot be found from the overlay network ON is stored in Step S21 that will be described later, the node processing unit 21b determines that there is a need to populate the content into the overlay network ON. Then, if the node processing unit 21b of the node N1 determines that there is a need to populate the content into the overlay network ON (yes in Step 10), the processing is advanced to Step S11. On the other hand, if the node processing unit 21b of the node N1 determines that there is no need to populate the content into the overlay network ON (no in Step 10), the processing illustrated in FIGS. 3A and 3B is completed.

In Step S11, the node processing unit 21b of the node N1 conducts the processing for populating the content. In the populating processing, the node processing unit 21b of the node N1 acquires the IP addresses and the port Nos. of a given number of nodes Nn that are population destinations of the content from the IP addresses and the port Nos. stored in the storage unit 23. For example, the IP address and the port No. of the node Nn that is a population destination are acquired from the IP addresses and the port Nos. which are registered in the routing table using the DHT. There is a case in which history information on transmission and reception of messages which have been conducted by the node processing unit 21b with respect to another node Nn through the overlay network ON is stored in the storage unit 23. If the IP addresses and the port Nos. of other nodes Nn are included in the history information, the IP addresses and the port Nos. of the node Nn that are the population destination may be acquired from the history information. The node processing unit 21b of the node N1 accesses to the node Nn on the basis of the respective acquired IP addresses and port Nos., and transmits a content saving request message to the node Nn. The node Nn that has received the content saving request message returns a content saving permission message to the node Nn, for example, if there is a free space for saving the content in the storage unit. The content saving permission message is a message for permitting the saving of the content. On the other hand, the node Nn that has received the content saving request message returns a content saving refusal message to the node Nn, for example, if there is no free space for saving the content in the storage unit. The content saving refusal message is a message for refusing the saving of the content. When the node processing unit 21b of the node N1 receives the content saving permission message, the node processing unit 21b acquires the content that has been temporarily saved in the buffer memory 22. Then, the node processing unit 21b of the node N1 transmits the content acquired from the buffer memory 22 to the node Nn that has transmitted the content saving permission message. Thus, the node Nn that has received the content saves the content, and serves as the content holding node.

Then, the node processing unit 21b of the node N1 deletes the content saved in the buffer memory 22 (Step S12), and completes the processing illustrated in FIGS. 3A and 3B.

In Step S13, the node processing unit 21b of the node N1 determines whether the index information has been received from the root node, or not. If the index information has been received from the root node (yes in Step S13), the processing is advanced to Step S14. On the other hand, if no index information has been received from the root node (no in Step S13), the processing is advanced to Step S16.

In Step S14, the node processing unit 21b of the node N1 selects the IP address and the port No. of the content holding node from the index information acquired from the root node.

Then, the node processing unit 21b of the node N1 transmits a content request message indicative of a request for acquiring the content requested from the viewing terminal T1-1 to the selected content holding node (Step S15), and the processing is advanced to Step S16. There is a case in which only the partial data required for starting the reproduction is required of the web server WS in the above Step S3. In this case, the node processing unit 21b of the node N1 may transmit the content request message indicative of a request for acquiring the content including data except the data required for starting the reproduction in the content requested from the viewing terminal T1-1 to the content holding node.

In Step S16, the node processing unit 21b of the node N1 determines whether the content has been received from the content holding node, or not. If the content has been received from the content holding node (yes in Step S16), the processing is advanced to Step S17. The processing of Steps S17 to S19 is conducted in the same manner as that of the processing in Steps S7 to S9. If the content from the web server WS is being received when the content is received from the content holding node, the reception of the content from the web server WS suspends. That is, the node processing unit 21b switches the transfer of the content received from the web server WS to the viewing terminal Tn-1 to the transfer of the content received from the content holding node to the viewing terminal T1-1 on the way. Through the above operation, the viewing terminal T1-1 can start the reproduction without waiting for more than the acquisition of the content from the web server WS.

On the other hand, if the content has not been received from the content holding node (no in Step S16), the processing is advanced to Step S20.

In Step S20, the node processing unit 21b of the node N1 determines whether the content absence message has been received, or not. If the content absence message has been received (yes in Step S20), the processing is advanced to Step S21. If the node processing unit 21b of the node N1 has not received the index information within a given time after the node processing unit 21b has transmitted the content location inquiry message in the above Step S5, the processing may be advanced to Step S21. On the other hand, if the content absence message has not been received (no in Step S20), the processing is returned to Step S6.

In Step S21, the node processing unit 21b of the node N1 stores information indicating that the content cannot be found from the overlay network ON.

Then, the node processing unit 21b of the node N1 determines whether the content acquisition request has been issued to the web server WS, or not (Step S22). Then, if the node processing unit 21b of the node N1 determines that the content acquisition request has been issued to the web server WS (yes in Step S22), the processing is returned to Step S6. On the other hand, if the node processing unit 21b of the node N1 determines that no content acquisition request has been issued to the web server WS (no in Step S22), the processing is returned to Step S23.

In Step S23, the node processing unit 21b of the node N1 transmits the HTTP request indicative of a request for acquiring the content requested from the viewing terminal T1-1 to the web server WS, and the processing is returned to Step S6. There is a case in which only the partial data required for starting the reproduction is required of the web server WS in the above Step S3. In this case, the content including data except the partial data required for starting the reproduction in the content may be required of the web server WS.

As has been described above, according to the above embodiment, while retrieving the location of a given content saved in the content holding node through the overlay network ON, at least the partial data required for starting the reproduction in the given content can be acquired from the web server WS. As a result, the node Nn can rapidly acquire the content at a stable speed. As a result, the viewing terminal T1-1 can rapidly start the reproduction of the content.

In the above embodiment, there is a high possibility that a reply from the web server WS is earlier than a reply from the content holding node on the overlay network ON. However, depending on situations that the processing performance of the web server WS is low, or a reply of the web server WS is slow because of the concentration of accesses, there is a case in which the reply from the content holding node is earlier than the reply from the web server WS. In this case, the node processing unit 21b of the node N1 transfers the content received from the content holding node to the viewing terminal T1-1 without waiting for transmission of the content from the web server WS. That is, the content acquired from any one of the web server WS and the content holding node, which is earlier in reply, is transferred to the viewing terminal T1-1. As a result, the viewing terminal T1-1 can rapidly start the reproduction of the content under any circumstances.

In the above embodiment, the stationary device in the present invention is exemplified by a relay device. However, the stationary device may be configured by a server connected to the network NW. The stationary device may be basically configured by a device such as a gateway stationary steadily connected to the network NW.

In the above embodiment, the peer to peer network using the DHT is applied to the overlay network ON. However, the present invention is not limited to this configuration. For example, a system using another overlay network may be applied to the overlay network ON. The peer to peer system using no DHT is exemplified by a hybrid peer to peer system.

Incidentally, according to the aspect of the disclosure, the data required for starting reproduction of the contents may be a configuration file which is used for reproducing a moving image file.

What is claimed is:

1. An information processing apparatus included in a delivery system in which a plurality of contents are stored in a plurality of node devices which are mutually communicate with each other through a network, the information processing apparatus comprising:
a first transmitting unit configured to transmit to, one of the node devices, a retrieval request indicative of a request for retrieving a location of a given content;
a second transmitting unit configured to transmit an acquisition request indicative of a request for acquiring at least first data required for starting reproduction of the given content to a delivery device that saves the first data;
a control unit configured to control the first transmitting unit to transmit the retrieval request, and control the second transmitting unit to transmit the acquisition request; and
an acquisition unit configured to acquire the given content in response to the retrieval request transmitted by the first transmitting unit, and acquire the first data in response to the acquisition request transmitted by the second transmitting unit.

2. The information processing apparatus according to claim 1, wherein the second transmitting unit transmits the acquisition request for acquiring data required for starting the reproduction of the given content to the delivery device.

3. The information processing apparatus according to claim 2, wherein the first transmitting unit transmits, to the given information processing apparatus, the retrieval request of the content including data except the data required for starting the reproduction.

4. The information processing apparatus according to claim 1, wherein
if the acquisition unit acquire the given content in response to the retrieval request transmitted by the first transmitting unit, the acquisition unit stops acquiring the first data in response to the acquisition request transmitted by the second transmitting unit.

5. The information processing apparatus according to claim 1, wherein
the information processing apparatus includes:
a stationary device that steadily enters into the network; and
a receiving unit that receives an acquisition request indicative of a request for acquiring the given content from a terminal device, and
in response to the receiving unit receiving the acquisition request, the control unit controls the first transmitting unit to transmit the retrieval request, and controls the second transmitting unit to transmit the acquisition request.

6. The information processing apparatus according to claim 1, wherein the acquisition request indicates a request for acquiring a control file required for reproducing the content.

7. The information processing apparatus according to claim 1, wherein
the acquisition request indicates a request for acquiring the content of a given size from a reproduction start position of the content on the reproduction time axis of the content.

8. The information processing apparatus according to claim 1 further comprising a determination unit configured to determine whether the given content is high in importance of reproduction or not,
wherein the control unit prohibits the transmission of the acquisition request by the second transmitting unit if the determination unit determines that the given content is not high in the importance of reproduction.

9. The information processing apparatus according to claim 8, wherein the determination unit determines that the given content is high in the importance of reproduction if the given content is data to be streamed.

10. The information processing apparatus according to claim 8, wherein
the content is karaoke data used in karaoke, and
the determination unit determines that the given content is high in the importance of reproduction if the given content is the karaoke data of a first track reserved in a karaoke equipment.

11. The information processing apparatus according to claim 8, wherein the determination unit determines whether the given content is high in the importance of reproduction, or not, on the basis of information included in a URL of the given content and indicative of a type of content.

12. The information processing apparatus according to claim 1, wherein the network is an overlay network.

13. The information processing apparatus according to claim 1, wherein
the first data includes at least one of a part of the content and a configuration file for reproducing the content.

14. A non-transitory computer readable storage medium storing an information processing program executable by the computer included in a delivery system in which a plurality of contents are stored in a plurality of node devices which are mutually communicate with each other through a network, the information processing program comprising instruction of:
transmitting to, one of the node devices, a retrieval request indicative of a request for retrieving a location of a given content;
transmitting an acquisition request indicative of a request for acquiring at least first data required for starting reproduction of the given content to a delivery device that saves the first data; and
acquiring the given content in response to the transmitted retrieval request; and
acquiring the first data in response to the transmitted acquisition request.

15. A delivery system in which a plurality of contents are stored in a plurality of node devices which are mutually communicate with each other through a network, the delivery system comprising:
a first transmitting unit configured to transmit to, one of the node devices, a retrieval request indicative of a request for retrieving a location of a given content;
a second transmitting unit configured to transmit an acquisition request indicative of a request for acquiring at least first data required for starting reproduction of the given content to a delivery device that saves the first data;
a control unit configured to control the first transmitting unit to transmit the retrieval request, and control the second transmitting unit to transmit the acquisition request; and
an acquisition unit configured to acquire the given content in response to the retrieval request transmitted by the first transmitting unit, and acquire the first data in response to the acquisition request transmitted by the second transmitting unit.

16. A method of acquiring a content in a delivery system in which a plurality of contents are stored in a plurality of node devices which are mutually communicate with each other through a network, the method comprising:
transmitting to, one of the node devices, a retrieval request indicative of a request for retrieving a location of a given content;
transmitting an acquisition request indicative of a request for acquiring at least first data required for starting reproduction of the given content to a delivery device that saves the first data;
acquiring the given content in response to the transmitted retrieval request; and
acquiring the first data in response to the transmitted acquisition request.
